(19) United States
(12) Patent Application Publication
(10) Pub. No.: US 2008/0012168 A1
(43) Pub. Date: Jan. 17, 2008

(54) Method for manufacturing printed circuit board

(75) Inventors: Senug-Hyun Ra, Seongnam-si (KR); Myeong-Ho Hong, Suwon-si (KR); Hyuk-Soo Lee, Seongnam-si (KR); Choon-Keun Lee, Suwon-si (KR); Sang-Moon Lee, Seoul (KR); Jae-Choon Cho, Suwon-si (KR); Jung-Woo Lee, Gunpo-si (KR); Jeong-Bok Kwak, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon-si (KR)

(21) Appl. No.: 11/826,007

(22) Filed: Jul. 11, 2007

(30) Foreign Application Priority Data
Jul. 11, 2006 (KR) 10-2006-0065050

(51) Int. Cl. B29C 43/20

(52) U.S. Cl. 264/104

(57) ABSTRACT

A method for manufacturing printed circuit board is disclosed. With a method for manufacturing a printed circuit board which includes: (a) stacking an insulation substrate, in which a first align hole is perforated, onto a support plate, to one side of which a guide pin is joined, such that the guide pin is inserted into the first align hole, where the first align hole is formed in correspondence with the guide pin, (b) stacking an imprinting mold, in which a second align hole is perforated, onto the support plate, such that the guide pin is inserted into the second hole formed in correspondence with the guide pin, and (c) stacking and pressing a pressing plate onto the support plate, and compressing the insulation substrate and the imprinting mold together, where an intaglio pattern is formed in a surface of the insulation substrate facing the imprinting mold, in correspondence with a circuit pattern, and a raised pattern is formed in a surface of the imprinting mold facing the insulation substrate, in correspondence with the circuit pattern, the installation of expensive aligning equipment is unnecessary in aligning an imprinting mold and an insulation substrate, and it is possible to form the intaglio patterns by imprinting on several insulation substrates at the same time by collectively stacking the several imprinting molds and the insulation substrates and compressing, and to prevent defects caused by the expansion and contraction of the insulation substrate which occur during the forming of the intaglio patterns.

### CROSS-REFERENCE TO RELATED APPLICATIONS

This application claims the benefit of Korean Patent Application No. 10-2006-0065050, filed with the Korean Intellectual Property Office on Jul. 11, 2006, the disclosure of which is incorporated herein by reference in its entirety.

### BACKGROUND

1. Technical Field

The present invention relates to a method, for manufacturing a printed circuit board, more particularly to a method for manufacturing the printed circuit board using an imprinting method.

2. Description of the Related Art

With developments in the electronics industry, electronic parts, including cellular phones, are becoming smaller and being equipped with more functionality creating a continuously increasing demand for smaller and higher-density printed circuit boards. At the same time, according to the trends of smaller and lighter electronic products, the printed circuit board is also becoming miniaturized, packaged, and endowed with finer patterns.

One technology for manufacturing fine circuit patterns that has been widely used until now is photolithography, which is a method of forming a pattern on a substrate laminated with a thin film of photoresist. However, the size of the patterns formed at this time is limited by an optical diffraction phenomenon, and the resolution is nearly proportional to the wavelength of the light beam used. Thus, the higher the level of integration of the semiconductor device, exposure of the shorter wavelength is required in order to form fine patterns. This, however, causes irregularities in the CD (critical dimensions) of the photoresist pattern, so that the circuit patterns formed using this photoresist pattern as a mask is made different from the circuit patterns first desired. Also, since the photoresist reacts with impurities generated during the process and becomes eroded, the photoresist pattern is altered. These are some of the reasons why the method of manufacturing the printed circuit board using the imprinting method for forming fine circuit patterns is currently receiving attention.

The method of imprinting for forming the pattern is to form the required shape in the surface of a material having a high relative strength and then imprint the shape such as by stamping, or to make a mold with the desired shape and then apply a polymer material inside the mold to form the pattern.

That is, in a method for forming printed circuit patterns using imprinting, first, an imprinting mold on which a raised pattern corresponding to the desired circuit pattern is formed is pressed onto the insulation substrate, and second, an intaglio pattern corresponding to the raised pattern is formed in the insulation substrate, where the circuit pattern is formed on the insulation substrate when this intaglio pattern is charged with the conductive material. Therefore, in order to form the circuit pattern on the insulation substrate by forming the exact intaglio pattern on the insulation substrate, it is of critical importance that the insulation substrate and the imprinting mold be exactly aligned.

FIG. 1 is a drawing showing a method for aligning a film mask and a substrate according to prior art. Referring to FIG. 1, a film mask 2, a substrate 4, an alignment mark 6 and a camera 8 are illustrated.

In the method of forming circuit patterns by conventional photolithography, the film mask 2 is stacked onto the top of the substrate in order to form the photoresist thin film. To do so, exact aligning is required between the film mask 2 and the substrate 4 in order to form fine circuit patterns and via holes for conduction between the upper layer of the substrate and the lower layer of the substrate 4 in their exact locations.

Conventionally, an optical system has been used for the exact aligning between the substrate 4 and the film mask 2. That is, while checking the alignment marks 6 through cameras 8 and moving the film mask 2 and the substrate 4, the film mask 2 and the substrate 4 were accurately aligned.

However, in the method for aligning according to prior art, at least one of the two layers to be aligned should be transparent. Therefore, aligning is only possible in circumstances where either the imprinting mold or the substrate is transparent. However, both the imprinting mold and the insulation substrate are opaque, so that the method for aligning according to prior art cannot be used.

Also, in the method for aligning according to prior art, two or more layers cannot be aligned at the same time in an application of a multilayer circuit board and are aligned sequentially.

In addition, local expansion and contraction generated in the substrate are different, so that the exact aligning between the imprinting mold and insulation substrate is difficult.

### SUMMARY

An aspect of the present invention is to facilitate the alignment of an insulation substrate and an imprinting mold, for the imprinting process of an imprinting mold in which a raised pattern is formed and an insulation substrate in which an intaglio pattern is formed in correspondence with the raised pattern, and to form the intaglio patterns by imprinting on several insulation substrates at the same time by collectively stacking the several imprinting molds and the insulation substrates and compressing.

Another aspect of the present invention is to prevent defects caused by the expansion and contraction of the insulation substrate which occur during the intaglio pattern formation.

One aspect of the present invention provides a method for manufacturing a printed circuit board which includes: (a) stacking an insulation substrate, in which a first align hole is perforated, onto a support plate, to one side of which a guide pin is joined, such that the guide pin is inserted into the first align hole, where the first align hole is formed in correspondence with the guide pin, (b) stacking an imprinting mold, in which a second align hole is perforated, onto the support plate, such that the guide pin is inserted into the second hole formed in correspondence with the guide pin, and (c) stacking and pressing a pressing plate onto the support plate, and compressing the insulation substrate and the imprinting mold together, where an intaglio pattern is formed in a surface of the insulation substrate facing the imprinting mold, in correspondence with a circuit pattern, and a raised pattern is formed in a surface of the imprinting mold facing the insulation substrate, in correspondence with the circuit pattern.

Before the pressing plate is stacked for forming the intaglio patterns on a plurality of base materials at the same time, the procedures may be performed repeatedly of (a) stacking an insulation substrate, in which a first align hole is perforated, onto a support plate, to one side of which a guide pin is joined, such that the guide pin is inserted into the first align hole, where the first align hole is formed in correspondence with the guide pin, and (b) stacking an imprinting mold, in which a second align hole is perforated, onto the support plate such that the guide pin is inserted into the second hole formed in correspondence with the guide pin.

In the present disclosure, the imprinting mold refers to the mold frame in which the required shape is formed in advance in the surface of a material whose relative strength is high. The pattern is formed by imprinting it such as by stamping onto another material or by applying a polymer material in the mold. The imprinting mold is a concept encompassing the stamp and the tool foil, etc.

It is possible, after a third align hole is perforated in the pressing plate, to stack the pressing plate onto the support plate such that the guide pin is inserted into the third align hole.

The pressing plate may be stacked onto the support plate and compressed. The intaglio pattern may be formed on the insulation substrate due to the compressing of the insulation substrate and the imprinting mold. The pressing plate may be separated from the support plate and the imprinting mold and insulation substrate are separated from the support plate, and the printed circuit pattern may be formed by filling conductive material into the intaglio pattern.

In the case of processing a plurality of identical unit PCB's in a large insulation substrate, local expansion and contraction may be resolved by forming a plurality of guide pins in the support plate on the side of the support plate.

Additional aspects and advantages of the present invention will become apparent and more readily appreciated from the following description, including the appended drawings and claims, or may be learned by practice of the invention.

### BRIEF DESCRIPTION OF THE DRAWINGS

FIG. 1 is a drawing showing a method for aligning a film mask and substrate according to prior art.

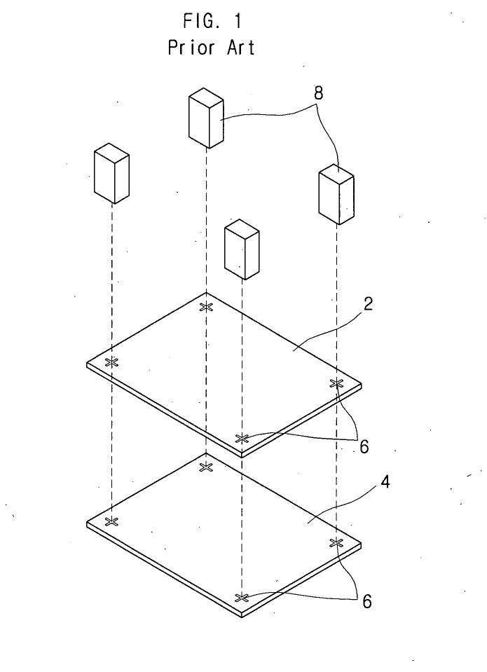

FIG. 2 is a perspective view showing a method for aligning according to an embodiment of the present invention.

FIG. 3 is a side view showing a method for aligning according to an embodiment of the present invention.

FIG. 4 is a side view showing the substrate in which a printed circuit pattern is formed according to an embodiment of the present invention.

FIG. 5 is a perspective view showing a method for aligning multiple layers according to an embodiment of the present invention.

FIG. 6 is a perspective view showing guide pins formed according to an embodiment of the present invention.

FIG. 7 is a flowchart showing a method for manufacturing a printed circuit board according to an embodiment of the present invention.

### DETAILED DESCRIPTION

Embodiments of the method for manufacturing printed circuit board according to the invention will be described below in more detail with reference to the accompanying drawings. In the description with reference to the accompanying drawings, those components are rendered the same reference number that are the same or are in correspondence regardless of the figure number, and redundant explanations are omitted.

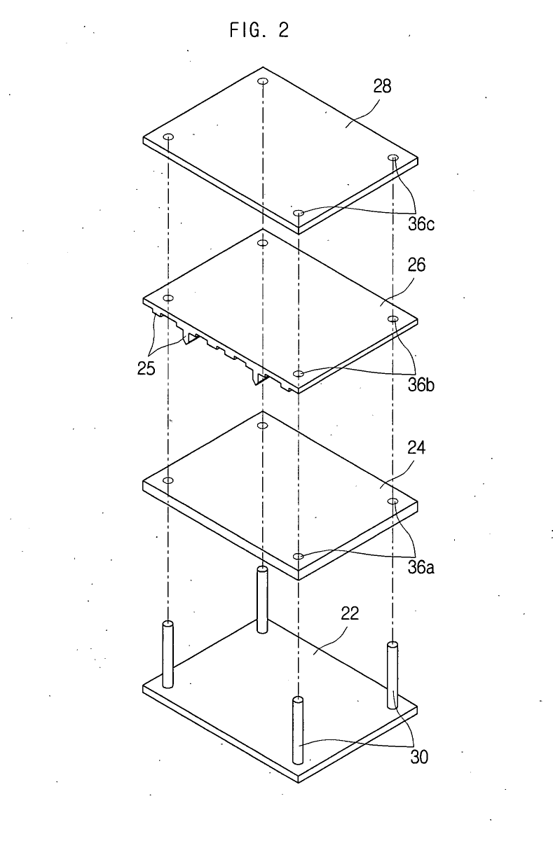

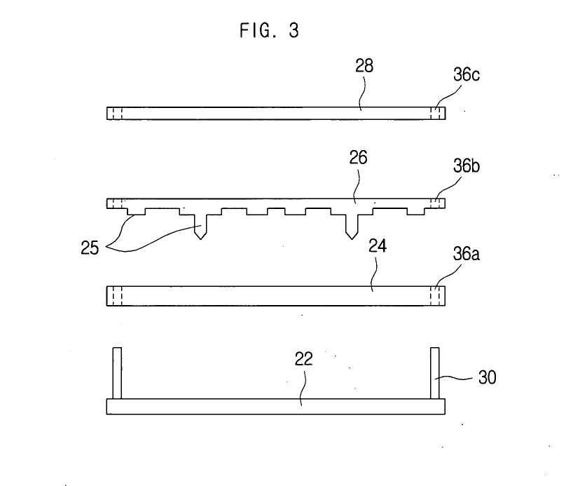

FIG. 2 is a perspective view showing a method for aligning according to an embodiment of the present invention. FIG. 3 is a side view showing a method for aligning according to an embodiment of the present invention. Referring to FIGS. 2 and 3, a support plate 22, an insulation substrate 24, an imprinting mold 26, a pressing plate 28, guide pins 30, a raised pattern 25 and align holes 36a, 36b, 36c are illustrated.

In this embodiment, an insulation substrate 24 having first align holes 36a perforated is stacked onto a support plate 22 having guide pins 30 joined to one side, such that the guide pins 30 are inserted into the first align holes 36a, where the first align holes 36a are formed in correspondence with the guide pins 30. An imprinting mold 26 having second align holes 36b perforated is stacked such that the guide pins 30 are inserted into the second holes 36b formed in correspondence with the guide pins 30.

When the pressing plate 28 is stacked and pressed, the imprinting mold 26 and the insulation substrate 24 are compressed together and simultaneously aligned, and then an intaglio pattern is formed in one side of the insulation substrate 24 as the raised pattern 25 formed in one side of the imprinting mold 26 is imprinted into the insulation substrate 24.

In this way, by aligning the imprinting mold 26 with the insulation substrate 24 and inserting the guide pins 30 processed precisely into the align hole, a finer circuit pattern can be formed in the insulation substrate 24.

The guide pins 30 formed on the side of the support plate 22 are joined perpendicularly and are made from a strong material. Moreover, the align holes 36a, 36b, 36c into which the guide pins 30 are inserted are perforated by means of a drill by computer numerical control (CNC) in order to be in accurate agreement with the guide pins 30.

While in this embodiment, the insulation substrate 24 is stacked on the support plate 22 first and the imprinting mold 26 is stacked onto the upper part of the insulation substrate 24 afterwards so that the raised pattern 25 of the imprinting mold 26 faces the insulation substrate 24, in some cases, it is possible to first stack the imprinting mold 26 onto the support plate 22 so that the raised pattern 25 faces the insulation substrate 24, and then have the insulation substrate 24 stacked and the pressing plate 28 stacked and pressed, so that the imprinting mold 26 and the insulation substrate 24 are then compressed together. That is, as long as the imprinting mold 26 and insulation substrate 24 are aligned in a pair such that the raised pattern 25 of the imprinting mold 26 faces a surface of the insulation substrate 24 to form the intaglio pattern, the stacking order of the insulation substrate 24 and the imprinting mold 26 is not of great importance.

Metals such as iron (Fe), nickel (Ni), platinum (Pt), and chrome (Cr), etc., and diamond or quartz, which are relatively strong in comparison with the insulation substrate 24, may be used as the material of the imprinting mold 26. Also, the raised pattern 25 formed in the imprinting mold 26 is not limited to certain shapes such as square shapes, V shapes, and U shapes, etc. Moreover, a thermoplastic resin may be used as the material of the insulation substrate 24.

However, the material of the insulation substrate 24 is not limited to thermoplastic resins and any material which is obvious to the person skilled in the art can be applied as the material of the insulation substrate 24. Also, a reinforcing substrate can be used in order to increase mechanical strength and minimize the effects of temperature. A reinforcing substrate obvious to the person skilled in the art, such as paper, fiber glass, and nonwoven glass fabric, etc., may be used as the reinforcing substrate. An insulating material obvious to the person skilled in the art, such as epoxy, polyimide, fluoric resin, and PPO resin, etc., may be used as the material of the insulation substrate 24.

It is possible to perforate third align holes, which align with the guide pins 30 of the support plate 22, also in the pressing plate 28 used for the compression of the imprinting mold 26 and the insulation substrate 24, to stack the imprinting mold 26 and the insulation substrate 24 onto the support plate 22 and afterwards stack the pressing plate 28 such that the guide pins 30 are inserted into the third align holes 36c.

The support plate 22 and the pressing plate 28 have sufficient strengths and thicknesses for forming a uniform pressure distribution over the imprinting mold 26 and the insulation substrate 24.

A press may be used for the compression in the method for pressing the support plate 22 and the pressing plate 28 together, but a heat-pressing method of applying may also be advantageous. This is so that the raised pattern 25 of the imprinting mold 26 is impressed in the insulation substrate 24 easily, after heat is applied to loosen the structure of the insulation substrate 24. Moreover, when applying the heat-pressing, it may be desirable to perform the compressing in a vacuum chamber while applying heat. A reason for pressurizing the inside of the vacuum chamber is to form a layer of air between the insulation substrate 24 and the imprinting mold 26 to prevent the occurrence of defects in the intaglio pattern formed in the insulation substrate 24.

Compression by means of a press may be used as the method for pressing the support plate 22 and the pressing plate 28 together. It is also possible to apply pressure using liquid or high-pressure gas.

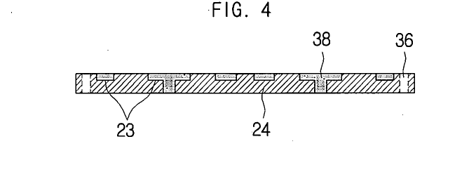

FIG. 4 is a side view showing the substrate in which a printed circuit pattern is formed according to an embodiment of the present invention. Referring to FIG. 4, an insulation substrate 24, align holes 36a, an intaglio pattern 23 and conductive material 38 are illustrated.

As described in the above, after the imprinting mold, the insulation substrate, and the pressing plate are stacked onto the support plate and pressed with a predetermined pressure, the pressing plate is separated from the support plate and the imprinting mold and insulation substrate 24 are separated from the support plate, the intaglio pattern 23 corresponding to the raised pattern of the imprinting mold is formed in the insulation substrate 24. The intaglio pattern 23 formed in this insulation substrate 24 is where the circuit pattern, including via holes, is formed, and it is charged with conductive material 38 in order to form the circuit pattern in the insulation substrate 24.

A method for filling the conductive material 38 obvious to the person skilled in the art may be applied, which includes non-electrolytic and/or electrolytic plating, filling with conductive paste, filling with conductive ink by ink-jet printing, and filling with conductive polymers, etc. A conductive material obvious to the person skilled in the art, including aluminum (Al), silver (Ag), copper (Cu), and chrome (Cr), etc., may be used as the conductive material 38 filled into the intaglio pattern 23 of the insulation substrate 24.

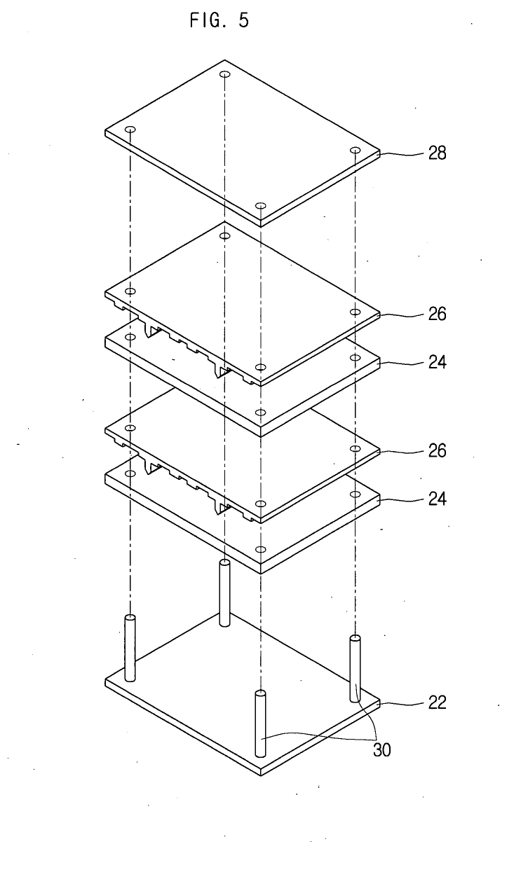

FIG. 5 is a perspective view showing a method for aligning multiple layers according to an embodiment of the present invention. Referring to FIG. 5, a support plate 22, an insulation substrate 24, an imprinting mold 26, a pressing plate 28 and guide pins 30 are illustrated.

In this embodiment, in order to form similar or dissimilar intaglio patterns on a plurality of insulation substrates 24 at the same time, an insulation substrate 24 having first align holes perforated is stacked onto a support plate 22 having guide pins 30 joined to one side, such that the guide pins 30 are inserted into the first align holes 36a, where the first align holes are formed in correspondence with the guide pins, and an imprinting mold 26 having second align holes perforated is stacked such that the guide pins 30 are inserted into the second holes, which are formed in correspondence with the guide pins 30. Then, a pressing plate 28 is stacked and pressed, so that the imprinting mold 26 and the insulation substrate 24 are aligned and compressed together such that an intaglio pattern is formed in one side of the insulation substrate 24 as the raised pattern 25 formed in one side of surface of the imprinting mold 26 is imprinted on the insulation substrate 24.

Before the pressing plate 28 is stacked and pressed, other imprinting molds 26 and insulation substrates 24 may be stacked repeatedly as in the above process, whereby a plurality of insulation substrates 24 having the intaglio patterns can be produced by one instance of pressing.

While in this embodiment only two unit insulation substrates 24 are stacked, it is apparent that a plurality of unit insulation substrates 24 having the intaglio pattern formed can be produced at the same time by stacking and compressing two or more unit insulation substrates 24 and unit imprinting molds 26.

The raised pattern formed in a plurality of imprinting molds 26 stacked on the support plate 22 may be the same or may be different. However, it is obvious that the locations of the align holes formed in each imprinting mold 26 have to be formed-in the locations corresponding to the guide pins 30 of the support plate 22.

After a plurality of unit imprinting molds 26 and unit insulation substrate 24 are stacked onto the support plate 22, the pressing plate 28 is stacked and pressed. With the plurality of unit imprinting molds 26 and unit insulation substrates 24 aligned, the plurality of unit insulation substrates 24 and unit imprinting molds 26 may be compressed at the same time, whereby a plurality of unit insulation substrates 24 can be produced in which intaglio patterns are formed.

While in this embodiment the method for stacking a plurality of the unit insulation substrates 24 and unit imprinting molds 26 involve first stacking the unit insulation substrates 24 and then the unit imprinting molds 26 onto the unit insulation substrates 24 so that the raised patterns of the unit imprinting molds 26 face the corresponding unit insulation substrates 24, in some cases, it is possible to first stack the imprinting molds 26 so that the raised patterns of the imprinting molds 26 face the insulation substrates 24 and to stack the insulation substrates 24 onto the imprinting molds 26, as described above. That is, when producing a plurality of insulation substrates 24, it does not matter in which order the unit imprinting molds 26 and the unit insulation substrates 24 are stacked, as long as they are arranged such that the raised pattern of a unit imprinting mold 26 and the surface of a unit insulation substrate 24, on which to form the intaglio pattern, face each other in a pair. This makes it possible to produce a plurality of unit insulation substrates having intaglio patterns formed therein, with just one operation of compressing. That is, in the case of producing of a plurality of insulation substrates 24, if the unit imprinting molds 26 and the unit insulation substrates 24 are aligned in pairs so that the raised pattern 25 of each unit imprinting mold 26 faces a surface of a unit insulation substrate 24 to form the intaglio pattern, the stacking order of the unit insulation substrates 24 and the unit imprinting molds 26 is not of great importance.

Besides this embodiment, the insulation substrate may be stacked onto the support plate, an imprinting mold may be stacked in which the raised pattern is formed on both sides may be stacked, and then another insulation substrate may be stacked and compressed, to produce two insulation substrates in which the raised pattern is formed at the same time in one set of one imprinting mold and two insulation substrates.

As described above, after a plurality of the unit imprinting molds 26, the unit insulation substrates 24, and the pressing plate are stacked onto the support plate and compressed, the pressing plate 28 is separated from the support plate 22, and the unit imprinting molds 26 and the unit insulation substrates 24 are separated from the support plate in reverse order of stacking, with the intaglio pattern 23 corresponding to the raised patterns of the imprinting molds formed in each of the unit insulation substrates 24. The intaglio patterns 23 formed in these unit insulation substrates 24 are where the circuit patterns including via holes are formed, and they are charged with conductive material 38 in order to form the circuit patterns on the insulation substrates 24.

A method for filling the conductive material 38 obvious to the person skilled in the art may be applied, including non-electrolytic and/or electrolytic plating, filling with conductive paste, filling with conductive ink by ink-jet printing, and filling with conductive polymers, etc.

A conductive material obvious to the person skilled in the art, including aluminum (Al), silver (Ag), copper (Cu), and chrome (Cr), etc., may be used as the conductive material 38 filled into the intaglio patterns 23 of the insulation substrates 24.

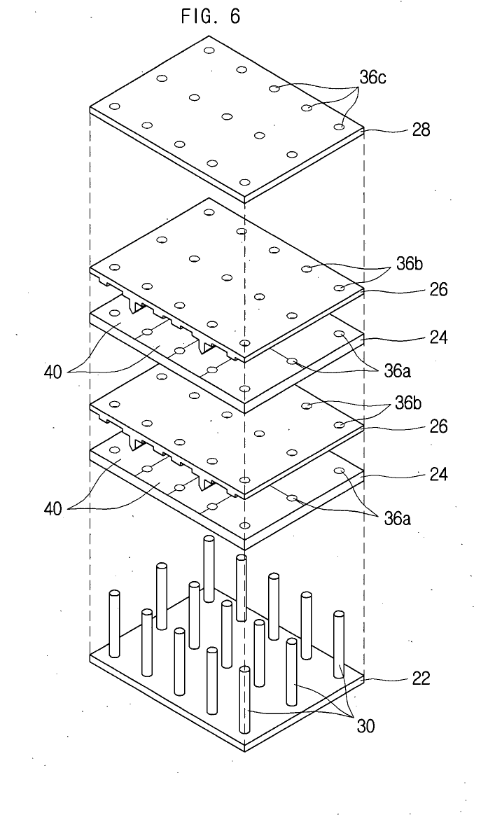

FIG. 6 is a perspective view showing guide pins formed according to an embodiment of the present invention. Referring to FIG. 6, a support plate 22, insulation substrates 24, imprinting molds 26, a pressing plate 28, guide pins 30, align holes 36a, 36b, 36c and unit PCB's 40 are illustrated.

In this embodiment, a plurality of guide pins 30 are formed on one side of the support plate 22. In the case of processing a plurality of identical unit PCB's 40 in one large insulation substrate, local expansion and contraction may be resolved by forming a plurality of guide pins 30 combined with the support plate on a side of the support plate 22.

Generally, in a PCB manufacturing process, a plurality of identical unit PCB's 40 are processed in one substrate at the same time, and then are cut into unit PCB's 40 afterwards. In the case of imprinting processing a plurality of identical unit PCB's 40 in an insulation substrate, the insulation substrate is relatively large, so that local expansion and contraction of the insulation substrate 24 may occur under the imprinting process and defects may be created in the intaglio patterns formed by the imprinting process. Thus, in this case, a plurality of guide pins 30 are formed on the part of the support plate 22 in portions corresponding to the dummy regions of the insulation substrate 24, and a plurality of align holes 36a, 36b are perforated corresponding to the plurality of guide pins, after which the imprinting molds 26 and insulation substrates 24 are aligned such that the plurality of guide pins are inserted into the plurality of align holes 36a, 36b. This makes it possible to prevent defects in the intaglio patterns that may occur due to local expansion and contraction.

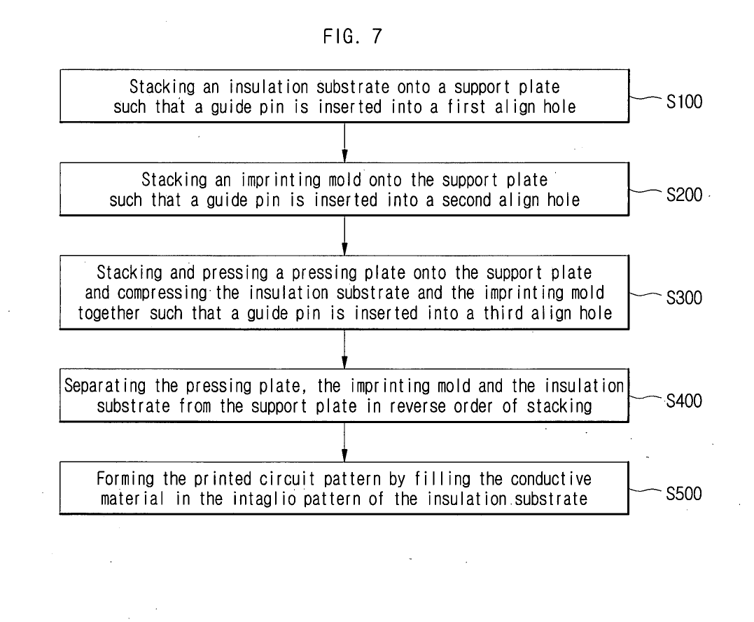

FIG. 7 is a flowchart showing a method for manufacturing a printed circuit board according to an embodiment of the present invention. Referring to FIG. 7, in operation S100, an insulation substrate in which a first align hole is perforated is stacked onto a support plate having a guide pin joined to one side, such that the guide pin is inserted into the first align hole, where the first align hole is formed in correspondence with the guide pin. The guide pin formed on the side of the support plate is mounted perpendicularly to the side of the support plate, and is made from a strong material. Moreover, the align hole through which the guide pin is inserted is perforated by means of a drill by computer numerical control (CNC) in order to be in accurate agreement with the guide pin.

Moreover, in the material of the insulation substrate, a reinforcing substrate may be used in order to increase mechanical strength and minimize the effects of temperature. A reinforcing substrate obvious to the person skilled in the art, such as paper, fiber glass, and nonwoven glass fabric, etc., may be used as the reinforcing substrate. An insulating material obvious to the person skilled in the art, such as epoxy, polyimide, fluoric resin, and PPO resin, etc., may be used as the material of the insulation substrate 24.

In operation S200, an imprinting mold in which a second align hole is perforated is stacked such that the guide pin is inserted into the second hole, which is formed in correspondence with the guide pin. In this way, by aligning the imprinting mold 26 with the insulation substrate 24 and inserting the guide pins 30 processed precisely into the align hole, a finer circuit pattern can be formed in the insulation substrate 24.

While in this embodiment, the insulation substrate is stacked on the support plate first and the imprinting mold is stacked onto the upper part of the insulation substrate afterwards so that the raised pattern of the imprinting mold faces the insulation substrate, in some cases, it is possible to first stack the imprinting mold onto the support plate so that the raised pattern faces the insulation substrate, and then have the insulation substrate stacked and the pressing plate stacked and pressed, so that the imprinting mold and the insulation substrate are then compressed together. That is, as long as the imprinting mold and insulation substrate are aligned in a pair such that the raised pattern of the imprinting mold faces a surface of the insulation substrate to form the intaglio pattern, the stacking order of the insulation substrate and the imprinting mold is not of great importance. Metals such as iron (Fe), nickel (Ni), platinum (Pt), and chrome (Cr), etc., and diamond or quartz, which are relatively strong in comparison with the insulation substrate, may be used as the material of the imprinting mold. Also, the raised pattern formed in the imprinting mold is not limited to certain shapes such as square shapes, V shapes, and U shapes, etc.

After this operation, in order to form similar or dissimilar intaglio patterns on a plurality of insulation substrates at the same time, other imprinting molds and the insulation substrates are stacked repeatedly as in the above process before the pressing plate is stacked and pressed, so that a plurality of insulation substrates having the intaglio patterns can be produced by one instance of pressing.

In operation S300, after an imprinting mold and the insulation substrate are stacked such that the guide pin is inserted into the align holes, a pressing plate is stacked and pressed, the imprinting mold and the insulation substrate are aligned and compressed together simultaneously and then an intaglio pattern is formed in one side of the insulation substrate as a raised pattern formed in one side of the imprinting mold is imprinted into the insulation substrate. In this way, by inserting the precision-processed guide pin into the align hole to align the imprinting mold with the insulation substrate, a finer circuit pattern can be formed in the insulation substrate.

It is possible to perforate a third align hole in the pressing plate used for the compression of the imprinting mold and the insulation substrate, to align the guide pin of the support plate, stack the imprinting mold and the insulation substrate onto the support plate and stack the pressing plate such that the guide pin is inserted into the third align hole.

The support plate and the pressing plate have sufficient strengths and thicknesses for forming a uniform pressure distribution over the imprinting mold and the insulation substrate.

A press may be used for the compression in the method for pressing the support plate and the pressing plate together, but a heat-pressing method of applying may also be advantageous. This is so that the raised pattern of the imprinting mold is impressed in the insulation substrate easily, after heat is applied to loosen the structure of the insulation substrate. Moreover, when applying the heat-pressing, it may be desirable to perform the compressing in a vacuum chamber while applying heat. A reason for pressurizing the inside of the vacuum chamber is to form a layer of air between the insulation substrate and the imprinting mold to prevent the occurrence of defects in the intaglio pattern formed in the insulation substrate. While compression by means of a press may be used as the method for pressing the support plate and the pressing plate together, it is also possible to apply pressure by using liquid or high-pressure gas.

In operation S400, after the imprinting mold, the insulation substrate, and the pressing plate are stacked onto the support plate and are pressed to a predetermined pressure, the pressing plate is separated from the support plate and the imprinting mold and insulation substrate are separated from the support plate, with the intaglio pattern corresponding to the raised pattern of the imprinting mold formed in the insulation substrate,-as described in the above.

In operation S500, the intaglio pattern formed in this insulation substrate is where the circuit pattern including via holes is formed, and it is charged with conductive material in order to form the circuit pattern on the insulation substrate. A method for filling the conductive material obvious to the person skilled in the art may be applied, which includes non-electrolytic and/or electrolytic plating, filling with conductive paste, filling with conductive ink by ink-jet printing, and filling with conductive polymers, etc. A conductive material obvious to the person skilled in the art, including aluminum (Al), silver (Ag), copper (Cu), and chrome (Cr), etc., may be used as the conductive material 38 filled into the intaglio pattern of the insulation substrate.

Many embodiments besides those described above are encompassed by the scope of claims set forth below.

As has been described, according to aspects of the present invention, the installation of expensive aligning equipment is unnecessary in aligning an imprinting mold and an insulation substrate. Also, it is possible to form the intaglio patterns by imprinting on several insulation substrates at the same time by collectively stacking the several imprinting molds and the insulation substrates and compressing, and to prevent defects caused by the expansion and contraction of the insulation substrate which occur during the forming of the intaglio patterns.

While the above description has pointed out novel features of the invention as applied to various embodiments, the skilled person will understand that various omissions, substitutions, and changes in the form and details of the device or process illustrated may be made without departing from the scope of the invention. Therefore, the scope of the invention is defined by the appended claims rather than by the foregoing description. All variations coming within the meaning and range of equivalency of the claims are embraced within their scope.

What is claimed is:

1. A method for manufacturing a printed circuit board, the method comprising:
(a) stacking an insulation substrate having a first align hole perforated therein onto a support plate having a guide pin joined to one side thereof, such that the guide pin is inserted into the first align hole, the first align hole being formed in correspondence with the guide pin;
(b) stacking an imprinting mold having a second align hole perforated therein onto the support plate such that the guide pin is inserted into the second align hole, the second align hole being formed in correspondence with the guide pin; and
(c) stacking and pressing a pressing plate onto the support plate and compressing the insulation substrate and the imprinting mold together,
wherein an intaglio pattern is formed in a surface of the insulation substrate facing the imprinting mold in correspondence with a circuit pattern, and a raised pattern is formed in a surface of the imprinting mold facing the insulation substrate, in correspondence with the circuit pattern.

2. The method for manufacturing a printed circuit board of claim 1, wherein the operation (a) and the operation (b) are performed repeatedly between the operation (b) and the operation (c).

3. The method for manufacturing a printed circuit board of claim 1, wherein a third align hole is perforated in the pressing plate in correspondence with the guide pin, and
the operation (c) comprises stacking the pressing plate onto the support plate such that the guide pin is inserted into the third align hole.

4. The method for manufacturing a printed circuit board of claim 1, further comprising after the operation (c):
(c1) separating the pressing plate from the support plate and separating the imprinting mold and the insulation substrate from the support plate;
(c2) forming a printing circuit pattern by filling the conductive material in the intaglio pattern.

5. The method for manufacturing a printed circuit board of claim 1, wherein the guide pin is formed in a plurality in one side of the support plate.
